(19) United States
(12) Patent Application Publication
(10) Pub. No.: US 2025/0292363 A1
(43) Pub. Date: Sep. 18, 2025

(54) WINDOW-BASED PARALLELIZED METHOD AND SYSTEM FOR PRODUCING SUPER-RESOLUTION MICROSCOPY IMAGE FROM AN IMAGE TIME-SERIES

(71) Applicant: UNIVERSITETET I TROMSØ - NORGES ARKTISKE UNIVERSITET, Tromsø (NO)

(72) Inventors: Sebastián Andrés Acuña Maldonado, Tromsø (NO); Krishna Agarwal, Tromsø (NO); Balpreet Singh Ahluwalia, Tromsø (NO)

(21) Appl. No.: 18/860,417

(22) PCT Filed: Nov. 29, 2022
(86) PCT No.: PCT/GB2022/053018

§ 371 Date: Oct. 25, 2024

(30) Foreign Application Priority Data
Apr. 27, 2022 (GB) 2206117.0

(51) Int. Cl. G06T 3/4053

(52) U.S. Cl. CPC G06T 3/4053

(57) ABSTRACT

A computer-implemented method of processing image data to produce an output image is provided, where the method comprises receiving image data comprising a stack of images, captured at different times, of part or all of a sample region containing a sample; selecting from the stack of images a plurality of windows, each window comprising a respective stack of spatially-coincident sections of the images, where each window is processed to determine indicator values for test points representative of a likelihood of a part of said sample being present at a location of the sample region corresponding to the test point, where the indicator values are combined to produce an output image of the part or all of the sample region.

### CROSS-REFERENCE TO RELATED APPLICATIONS

This application is a 35 U.S.C § 371 National Stage Entry of International Application No. PCT/GB2022/053018, filed Nov. 29, 2022, which claims the priority benefit of United Kingdom Application No. GB 2206117.0 filed Apr. 27, 2022, the contents of all of which are hereby incorporated herein by reference in their entireties for all purposes.

### BACKGROUND OF THE INVENTION

The present invention relates to methods and systems for processing image data to produce an output image, e.g. a super-resolution image.

Optical microscopes are used within histology, cell biology and related fields to view biological samples such as cells. However, the resolving power of optical microscopes is limited due to the diffraction limit of light. This limitation restricts the resolution of visible light microscopy to around 200 to 300 nm. In order to overcome this limit, several techniques have been developed in the art, termed “nanoscopy”, “super-resolution imaging”, or “super-resolution microscopy”.

These super-resolution imaging techniques allow imaging of a biological sample with a resolution finer than 200 nm, and even down to around 20 to 50 nm. They typically process light emitted from markers, such as photo-switchable fluorophores or quantum dots, that have been attached to, or embedded within, the biological sample. Known examples of such super-resolution techniques include ensemble techniques such as Structured Illumination Microscopy (SIM) and Stimulated Emission Depletion Microscopy (STED), single-molecule localisation techniques such as Photo-Activated Localization Microscopy (PALM) and Stochastic Optical Reconstruction Microscopy (STORM), and fluctuation-based super-resolution techniques such as Multiple Signal Classification Algorithm (MUSICAL).

Fluctuation-based super-resolution imaging techniques such as MUSICAL utilise photo-kinetic phenomena such as fluorescence for super-resolution imaging. For instance, the photon emissions of fluorescent molecules are independent of each other and fluctuate over time. The photon emissions captured by an imaging system may also fluctuate over time due to motion of one or more parts of a sample. An imaging system captures a time-series of images and processes the image data in an image processing system that carries out statistical analysis of the temporal fluctuations to produce a super-resolution image. However, the computational burden associated with these statistical methods can be large.

The present invention aims to provide improved approaches to fluctuation-based imaging including, for instance, fluctuation-based super-resolution imaging.

### SUMMARY OF THE INVENTION

According to a first aspect of the present invention there is provided a computer- implemented method of processing image data to produce an output image, the method comprising:
receiving image data comprising a stack of images, captured at different times, of part or all of a sample region containing a sample;
selecting from the stack of images a plurality of windows, each window comprising a respective stack of spatially-coincident sections of the images;
for each window:
   decomposing the window into eigenimages and corresponding singular values;
   calculating, for each of a plurality of test points in the window, a respective first value as a first function of the eigenimages of the window;
   calculating, for each of the plurality of test points in the window, a respective second value as a second function of the eigenimages of the window; and
   determining, from the first and second values, a respective indicator value for each test point, representative of a likelihood of a part of said sample being present at a location of the sample region corresponding to the test point; and
combining the indicator values to produce an output image of the part or all of the sample region,
   wherein at least one of the decomposing, calculating or determining steps is carried out for a first window of the plurality of windows at the same time as at least one of the decomposing, calculating or determining steps is carried out for a second window of the plurality of windows.

According to a second aspect of the present invention there is provided an image processing system for producing output images, comprising:
an input interface for receiving image data comprising a stack of images, captured at different times, of part or all of a sample region containing a sample; and
a plurality of processors,
   wherein the image processing system is configured, for each of a plurality of windows selected from the image data, each window comprising a respective stack of spatially-coincident sections of the images, to use one or more of the plurality of processors to:
decompose the window into eigenimages and corresponding singular values;
calculate, for each of a plurality of test points in the window, a respective first value as a first function of the eigenimages of the window;
calculate, for each of the plurality of test points in the window, a respective second value as a function of the eigenimages of the window; and
determine, from the first and second values, a respective indicator value for each test point, representative of a likelihood of a part of said sample being present at a location of the sample region corresponding to the test point; and
   wherein the image processing system is configured to combine the indicator values to produce an output image of the part or all of the sample region, and wherein the image processing system is configured to cause at least one of the decomposing, calculating or determining steps to be carried out for a first window of the plurality of windows by a first processor of the plurality of processors, at the same time as at least one of the decomposing, calculating or determining steps is carried out for a second window of the plurality of windows by a second processor of the plurality of processors.

It will be appreciated by those skilled in the art that carrying out at least one of the decomposing, calculating or determining steps for a first window at the same time as at least one of the decomposing, calculating or determining steps is carried out for a second window (i.e. carrying out decomposing and/or calculating and/or determining processes in parallel) increases the efficiency with which the image may be produced. In some embodiments, the output image is a super-resolution image. This may enable super-resolution imaging without requiring unfeasibly long computation times and/or extensive computational resources. For instance, it may facilitate the production of super-resolution time-lapse sequences (e.g. of a live cell sample) with readily available computation resources in manageable time (e.g. within seconds or minutes, rather than days or weeks). In some embodiments, the method may even enable real-time or near real-time super-resolution imaging (e.g. in which a stack of images is processed to produce a super-resolution image in a time period equal to or less than that in which the images were captured). Furthermore, separating the image data into a plurality of windows (i.e. rather than processing the whole image at once) may help to improve the eventual image quality by suppressing the contribution of data due to noise present in other windows.

The light emitted from a sample (i.e. from a part of the sample) has an intensity pattern that depends not only upon the physical distribution of particles within the sample, but also upon other factors that may change over time, such as the stochastic nature of fluorescence (blinking), chemical changes within the sample, the motion of particles within the sample, the motion of one or more parts of the sample, changes to the optical properties of one or more parts of the sample (e.g. due to chemical changes). Raman scattering may also produce intensity fluctuations. Intensity fluctuations may also arise from image processing techniques applied to the image data (e.g. a reconstruction algorithm). For instance, phase images or intensity images reconstructed from an interferometric imaging or microscopy system, Fourier tychography system, etc. Further, fluctuations in intensity may also be created artificially by illuminating the sample with illumination patterns that fluctuate over time. The patterns and fluctuations may be systematic, periodic, pseudo-random, or random.

As a result of one or more of these effects, the different images in the stack of images typically contain different intensity patterns. Further variations in the intensity patterns may occur due to imaging noise (e.g. shot noise, quantization nose, dark current noise). By processing the image data as disclosed herein, the temporally-varying intensity patterns may be utilised to produce a super-resolution image of the sample (i.e. an image in which the structure of the sample is resolved with an accuracy beyond the diffraction limit of the apparatus used to capture each original image of the stack) and/or a contrast-enhanced and/or a noise-suppressed image (i.e. an image in which the structure of the sample appears with better clarity than in any one of the raw stack of images).

The sample may be a biological sample, e.g. containing part or all of one or more biological structures. In a set of embodiments the sample comprises one or more sperm cells (e.g. comprising a semen sample). In a set of embodiments the sample comprises one or more bacteria (e.g. comprising a bacteria culture sample).

In a set of embodiments, the sample comprises one or more moving parts, such as a molecule, a cell structure, a cell or a collection of cells. It will be recognised that where motion of a part of the sample contributes to intensity fluctuations, the method disclosed here may facilitate reconstruction of motion patterns. In some such embodiments, the respective indicator value for one or more test points (e.g. all test points) may represent a likelihood of a moving part of said sample being present at a location of the sample region corresponding to the test point. In contrast, in some embodiments, the sample is substantially or completely stationary in the image data.

In a set of embodiments, the sample is a fluorescing sample, e.g. comprising one or more fluorophores. Fluorescence may arise from artificially added fluorophores or from autofluorescence of fluorophores inherent in the sample. In some such embodiments, the respective indicator value for one or more test points (e.g. all test points) represents a likelihood of a fluorophore being present at a location of the sample region corresponding to the test point. In contrast, in some embodiments, the sample exhibits substantially or completely no fluorescence in the image data.

The images of the stack preferably all image an identical area of the sample region. They may have the image resolution (e.g. pixels per inch). They may all be rectangular, although this is not essential. The stack may be a time-series of images, which may correspond to regular time intervals.

Each window preferably spans the full depth (i.e. time axis) of the stack of images. The plurality of windows preferably collectively includes all of the data in the image stack (i.e. every part of the image stack is included in at least one window). The respective spatially-coincident sections of the plurality of windows may have the same shape and/or size (i.e. in the image plane). In some embodiments the sections are all squares. They may all be equal-sized squares. Thus a window may comprise a spatially-aligned square section of each image. Because all the image sections of any window are spatially coincident (i.e. have the same position within each image of the stack), each window may correspond to a different respective area of the sample region over time. The plurality of windows may overlap. In some embodiments, the windows are selected to each have a size of at least half of a point spread function of an imaging apparatus that captured the stack of images, and preferably the windows each have a size of between one and two times the point spread function of the imaging apparatus that captured the stack of images. In some embodiments the windows are rectangles having sides each at least three pixels in length, and preferably at least five pixels in length. This may avoid artefacts associated with discretization errors.

In a set of embodiments, each image in the stack of images comprises a plurality of pixels, and a respective window is selected centred on each of the pixels of an image of the stack of images. In other words, the plurality of windows may comprise as many windows as there are pixels in each image of the stack of images. In some embodiments, some of the windows may extend beyond the edge of the image data (e.g. windows centred on an edge pixel). In such embodiments empty portions of these windows may be filled with a predetermined pixel value, or an average (e.g. mean) of the image data pixels in that window, or a floor value of the image data pixels in that window.

The eigenimages into which each window is decomposed may represent particular patterns of intensity found in the stack of images, with the corresponding singular values indicating the relative prominence of each pattern in the stack. For example, a large singular value may indicate that the pattern of the corresponding eigenimage is a prominent pattern in the image stack (i.e. one which is more likely to be due to inherent structure in the sample than due to random noise).

Decomposing one or more of the windows into eigenimages and corresponding singular values may comprise a singular value decomposition (SVD) process. Additionally or alternatively, decomposing one or more of the windows into eigenimages and corresponding singular values may comprise an eigenvalue decomposition (ED) process.

In some sets of embodiments, the method comprises decomposing the first window into eigenimages and corresponding singular values at the same time as decomposing the second window into eigenimages and corresponding singular values (i.e. the method may comprise decomposing at least two windows in parallel). The first processor may decompose the first window into eigenimages and corresponding singular values at the same time as the second processor decomposes the second window into eigenimages and corresponding singular values. The inventors have recognised that this step may be particularly suitable for parallelisation because each of the windows can be decomposed independently.

In some sets of embodiments, each first value represents a contribution to its respective test point of one or more signal eigenimages (i.e. those which represent patterns that are prominent in the image stack). Each second value may represent a contribution to its respective test point of one or more noise eigenimages (i.e. those patterns that are not prominent in the image stack). Accordingly, in some embodiments the first and/or second function includes a projection operation.

Calculating the first value may comprise projecting a point spread function (PSF) of the respective test point onto one or more eigenimages of the window. Correspondingly, calculating the second value may comprise projecting a PSF of the respective test point onto one or more eigenimages of the window.

In some embodiments, the first value consists of a contribution to the test point of a single eigenimage and/or the second value consists of a contribution to the test point of a single eigenimage. In such embodiments, determining the respective indicator value for each test point may comprise combining a plurality of first values and/or combining a plurality of second values. Alternatively, in some embodiments, each first value and/or each second value comprises a combination of contributions to the test point of a plurality of eigenimages. In other words, the method may comprise combining contributions from eigenimages in a calculating step or in the determining step.

In some embodiments it may be useful to apply different weights to the contributions from different eigenimages. Accordingly, some embodiments comprise applying a first weight function and/or a second weight function to eigenimages of the window. The weight functions may be applied in a calculating step or the determining step. In embodiments where each first value and/or each second value comprises a combination of contributions to the test point of a plurality of eigenimages (i.e. where the combining happens in the calculating step), calculating each first value may include applying a first weight function which weights eigenvalue contributions to the first value (e.g. the first value comprises a weighted sum of eigenvalue contributions defined by the first weight function). Similarly, calculating each second value may include a second weight function which weights eigenvalue contributions to the second value (e.g. the second value comprises a weighted sum of eigenvalue contributions defined by the second weight function).

Alternatively, in embodiments where the first value consists of a contribution to the test point of a single eigenimage and/or the second value consists of a contribution to the test point of a single eigenimage (e.g. where the combining happens in the determining step), determining the respective indicator value for a test point may comprise combining a plurality of first values using a first weight function (e.g. as a weighted sum defined by the first weight function) and/or combining a plurality of second values using a second weight function (e.g. as a weighted sum defined by the second weight function).

In some embodiments, calculating the first and/or second value may comprise first projecting a point spread function (PSF) of the respective test point onto several eigenimages, and then calculating a weighted sum of the projection results according to the corresponding first and/or second weight function. Alternatively, calculating the first and/or second value may comprise first applying a weight to a plurality of eigenimages, projecting a PSF of the respective test point onto the weighted eigenimages and then simply summing the result without further weighting.

The first and/or second weight functions may be a function of one or more properties of the eigenimages or one or more properties related to the eigenimages. In a set of embodiments, the first and/or second weight function is a function of the corresponding singular values of the eigenimages. In other words, the weight applied to the contribution of an eigenimage may be determined based on the singular value corresponding to that eigenimage.

Weighting contributions from eigenimages may include assigning a weight of zero to one or more eigenimages, i.e. excluding that eigenimage from contributing to the first/second value. Weighting contributions from eigenimages may include assigning a weight of one to one or more eigenimages, i.e. selecting fully that eigenimage to contribute to the first/second value. In other words, the first and/or second weight function may be equal to one or zero for one or more eigenimages (e.g. for ranges of corresponding singular values).

In some embodiments, the first weight function selects fully (i.e. applies a weight of one) contributions from a first set of eigenimages that satisfy a first condition or a set of first conditions, and excludes (i.e. applies a weight of zero) other eigenimages. The second weight function may select fully contributions from a second set of eigenimages that satisfy a second condition or a set of second conditions, and exclude other eigenimages. The first and second condition(s) may be different. The first and second sets may be non-overlapping (i.e. with no eigenimages appearing in both sets). For instance, the first and second weight functions may effectively split the eigenimages into two sets, with one set used to calculate the first value(s) for each test point and the other set used to calculate the second value(s) for each test point. In some embodiments one or more of the eigenimages is not included in either set.

The first and/or second conditions may comprise a minimum or maximum threshold to which a property of the eigenimage or a property related to the eigenimage (e.g. its corresponding singular value) is compared. For instance, the first weight function may select all eigenimages with a corresponding singular value above a first threshold value, and/or the second weight function may select all eigenimages with a corresponding singular value below a second threshold value (i.e. the first and/or weight second functions may comprise step functions with a value of zero on one side of the first/second threshold and a value of one on the other side of the first/second threshold). In other words, in a set of embodiments, calculating the first value for each test point may comprise calculating a first contribution to the test point of the eigenimages of the window that have a corresponding singular value greater than a first threshold value. Additionally or alternatively, calculating the second value for each test point may comprise calculating a second contribution to the test point of the eigenimages of the window that have a corresponding singular value less than a second threshold value.

The first and second thresholds may be equal, e.g. such that the first and second weight functions are step functions that are inverted versions of each other. In such embodiments the eigenimages are effectively divided between the first and second sets about a common threshold value. In such embodiments any eigenimages of a window that have a corresponding singular value equal to the common threshold value (i.e. not greater than or less than) may be included with the first set (or, alternatively, in other embodiments, may be included with the second set). In other words, in a set of embodiments, calculating the first value for each test point may comprise calculating a first contribution to the test point of the eigenimages of the window that have a corresponding singular value greater than a common threshold value. Additionally or alternatively, calculating the second value for each test point may comprise calculating a second contribution to the test point of the eigenimages of the window that have a corresponding singular value less than a common threshold value. Eigenimages of the window that have a corresponding singular value equal to the common threshold value may be used for calculating the first value, the second value, neither value or both values.

The first and/or second weight functions may be discontinuous or continuous. The first and/or second weight functions may include linear expressions, polynomial expressions, exponential expressions and/or logarithm expressions. The weight functions may have different parameters and/or forms for different input ranges (e.g. different ranges of singular values). The first and/or second weight function may be defined partially or entirely by a look-up table. For instance, the first and/or second weight functions may be defined by a list of singular values or ranges of singular values and corresponding weights (e.g. in a look-up table). The weight functions may be defined graphically by a user (e.g. by manually drawing a weighting curve using a user interface such as a touch screen).

In some embodiments, calculating the first and second values for a window comprises multiplying a test matrix, comprising the PSFs for the test points in that window, with the eigenvalues of that window to produce a projection matrix.

The first and second values may then be calculated by summing elements of the projection matrix according to first and second weight functions as discussed above. This process allows all of the first and second values for a given window to be calculated using a single set of matrix manipulations, which may be more efficient than individual calculations for each test point. For instance, in embodiments where the first weight function is a step function defined by a first singular value threshold, the first values may be calculated by summing those elements of the projection matrix that have corresponding singular values greater than the first singular value threshold. In embodiments where the second weight function is a step function defined by a second singular value threshold, the second values may be calculated by summing those elements of the projection matrix that have corresponding singular values less than the second singular value threshold.

In embodiments where the when the first and second weight functions are both step functions and the first and second singular value thresholds are equal, it will be appreciated that the projection matrix is effectively divided into two sections corresponding respectively to the first and second values.

In some embodiments, the first and/or second values for the first window are calculated at the same time as the first and/or second values for the second window. The first processor may calculate first or second values for each of a plurality of test points in the first window at the same time as the second processor calculates first or second values for each of a plurality of test points in the second window.

The indicator values may represent the likelihood of a part of the sample (e.g. part or all of a structure in the sample) being present at the test-point location in any suitable way. They are not necessarily equal to actual probability values (e.g. between zero and one), although they may scale linearly with statistical likelihood. In embodiments where the sample is a fluorescing sample, the indicator values may represent the likelihood of a fluorophore being present at the test-point location in any suitable way.

As mentioned above, in some examples, determining the respective indicator value for each test point may comprise combining a plurality of first values for each test point and/or combining a plurality of first values for each test point. The plurality of first and/or second values may be combined using first and/or second weight functions as described above.

Determining the respective indicator value for a test point may comprise dividing the first value or the combination of first values for the test point by the second value or the combination of second values for the test point. The result of this division may be raised to the power of another value, referred to herein as a contrast index, to increase or decrease a contrast level in the output image. The contrast index may be predetermined, e.g. chosen for a particular imaging apparatus that captured the image data. The contrast index may be selected by a user. In a set of embodiments the contrast index is between one and five and is preferably approximately two.

The first and/or second weight functions (e.g. first and/or second threshold values) may be predetermined (i.e. fixed before the method is performed and possibly even before any image data is captured). For example, the first and/or second weight function (e.g. first and/or second threshold values) may be determined based at least in part on one or more characteristics of imaging apparatus used to produce the image data (e.g. a sample holder, imaging optics and/or an image sensor). The first and/or second weight function (e.g. first and/or second threshold values) may be determined based at least in part on one or more known properties of the sample. The first and/or second weight function (e.g. first and/or second threshold values) may be the same as or derived from a previously-used function (e.g. first and/or second threshold values that previously returned good imaging results).

Using predetermined functions may allow the calculating steps to be carried out for a window as soon as that window has been decomposed (i.e. without any need to wait for other windows to be decomposed). This may reduce the number and/or volume of data transfers required between processors and may improve the overall efficiency of the system. For instance, a single processor may be arranged to execute all of the decomposing, calculating and determining steps for a single window without needing to transfer data to or from other elements in between these steps. Alternatively, in some embodiments where the first and/or second weight functions are predetermined (i.e. not dependent on the outcome of the decomposing steps), one or more of the calculating or determining steps for one or more windows may be performed at the same time as one or more other windows are still being decomposed. This may allow for more optimal resource use, because processors that would otherwise be idle can be used to start the calculating or determining steps whilst the decomposing step is still being performed by other processors.

In some sets of embodiments, the first and/or second weight function (e.g. first and/or second threshold values) is determined based at least partially on the image data. For example, the method may comprise determining the first and/or second weight function (e.g. first and/or second threshold values) based on eigenimages and/or corresponding singular values of one or more of the windows. One or more of the processors may be arranged to determine the first and/or second weight function based at least partially on the image data.

Additionally or alternatively, in some embodiments the first and/or second weight function (e.g. first and/or second threshold values) is determined based at least partially on a user input. In other words, the method may comprise receiving an input from a user and determining the first and/or second weight function (e.g. first and/or second threshold values) based at least partially on said input. In some embodiments, the method may comprise providing to a user a representation of one or more of the corresponding singular values (e.g. a distribution of the singular values), to allow a user to interpret and select the appropriate first and/or second weight function (e.g. a suitable first and/or second threshold singular values). The image processing system may comprise a user interface for receiving an input from a user (e.g. for receiving information that determines or leads to the determination of the first and/or second weight function) and/or for providing an output to a user (e.g. a representation of one or more of the corresponding singular values). The user interface may comprise an output device such as a display and/or an input device such as a keyboard and/or mouse.

In some sets of embodiments, the method comprises decomposing all of the windows before any of the calculating and/or determining steps is carried out. In some such embodiments, the method may comprise decomposing at least a subset, and potentially all, of the plurality of windows at the same time (i.e. in parallel). However, as explained above, in some embodiments it may be efficient (e.g. to maximise utilisation of a fixed computing resource) to carry out one or more of the calculating and/or determining steps for one or more windows at the same time as one or more other windows are still being decomposed.

Each window may be decomposed into a full set of eigenimages and corresponding singular values. However, in some embodiments, a window is decomposed into only a partial set of eigenimages (e.g. eigenimages which have a minimum and/or maximum corresponding singular value). In such embodiments, the partial set of eigenimages may be used to calculate the first values for that window. In some such embodiments, the second values for that window may then be calculated from the partial set of eigenimages without explicitly computing any further eigenimages.

For instance, as mentioned above, the first values may represent contributions to their respective test point of signal eigenimages and the second values may represent contributions to their respective test point of noise eigenimages. In such cases the signal and noise eigenimages may be orthogonal, and this orthogonality allows the second values to be calculated without explicitly decomposing the window into noise eigenimages.

The image processing system may comprise memory storing software for execution by the plurality of processors. The software may comprise instructions which, when executed, cause said one or more of the plurality of processors to perform operations as disclosed herein.

The plurality of processors may comprise a plurality of individual processors (e.g. provided by different respective semiconductor chips), or a plurality of processor cores (e.g. of the same processor), or a mixture of processors and processor cores. The plurality of processors may comprise two or more different types of processors. One or more of the processors may comprise a central processing unit (CPU). One or more of the processors may comprise a graphics processing unit (GPU). The inventors have recognised that GPUs may be particularly suitable for performing the decomposing, calculating or determining steps, as they may be optimised for performing such operations at high speed.

In some embodiments, the image processing system comprises a comparable number of processors to the number of windows selected (e.g. an equal number, or within +/−10% or 20%). As mentioned above, the number of windows selected may be based on or equal to the number of pixels in the image data. For example, there may be a hundred, a thousand or even a million or more windows. In some embodiments, the image processing system comprises at least one processor for every 100 windows, or every ten windows, or every three windows, or even one processor for every window. In some embodiments, the number of processors arranged to perform at least one of the decomposing and/or calculating and/or determining steps is exactly equal to the number of windows of the image stack that are processed by the image processing system. Providing one processor for every window or small number of windows may enable optimal parallelisation as each processor can perform the decomposition and/or the calculating steps and/or the determining step for its own window. The processing system may comprise at least 10 processors, or at least 20 processors, or at least 100 processors. Each processor may access a shared main memory of the image processing system and/or may be associated with a respective local memory, which it may use for storing input data, output data and intermediate results.

In a set of embodiments, the image processing system comprises a single computing device (e.g. a workstation) that comprises the input interface, the memory and the plurality of processors. In some embodiments, the image processing system may comprise a standard desktop, laptop or tablet computer.

In some embodiments, the image processing system comprises a plurality of computing devices. At least one of the plurality of computing devices may be located physically apart from at least one other of the plurality of computing devices, for instance located in a different physical server rack slot, or a different room, or a different building, or even a different country. In such embodiments, the computing devices may be connected over a network, such as an internet protocol (IP) network, which include one or more electrical and/or optical and/or radio links.

The memory storing the software may be in a single location (e.g. a centralised main memory) or may be distributed (e.g. comprising local memories in each of the computing devices). The software may comprise a plurality of software components, some or which may be independently executable.

In some embodiments, the plurality of processors are provided by a plurality of computing devices, i.e. with each computing device comprising one or more of the plurality of processors. In other words, the image processing system may be a distributed image processing system in which processing is distributed amongst a plurality of computing devices. As mentioned above, at least one of the computing devices may be remote from the others.

In some embodiments, additionally or alternatively, the input interface may be provided on a different computing device to one or more of the plurality of processors. In one embodiment, the input interface is provided by a local computing device (e.g. a personal computer) and at least one, and potentially all, of the plurality of processors is provided by a remote server or a plurality of remote servers. For example, the image processing system may provide a cloud (i.e. networked) computing service, and a user may upload the image data from a local computing device to one or more remote servers for processing. In some such embodiments, additionally or alternatively, the local computing device comprises at least one of the plurality of processors.

The image processing system may comprise a data storage module for storing the image data and/or output data (e.g. the output image) and/or intermediary data (e.g. eigenimages or singular values). At least part of the data storage module may be provided remotely to one or more or all other components of the image processing system. The data storage module may provide the memory on which software is stored, or this may be provided separately. The data storage module may provide working memory for some or all of the plurality of processors, however the processor may additionally or alternatively use working memories that are local to each processor. The processors may be arranged to retrieve image data corresponding to the windows from the data storage module—e.g. over one or more data links.

In some sets of embodiments the image processing system comprises a scheduler. The scheduler may be responsible for coordinating the plurality of processors, e.g. to allocate processing tasks to processors. The scheduler may comprise a processor (e.g. a main processor) which may be separate from the plurality of processors used to process the image windows. In such examples, the plurality of processors, not part of the scheduler, may be considered to be auxiliary processors. In a set of embodiments, the scheduler comprises a central processing unit. In such embodiments each other processor may comprise a respective graphical processing unit (GPU).

In some embodiments, the scheduler is arranged to define the plurality of windows and/or to allocate windows to different processors. For instance, in a set of embodiments, the image processing system comprises:
a data storage module arranged to store the image data; and
a scheduler;
   wherein the scheduler is configured to define the plurality of windows and to allocate each window to a respective processor of the plurality of processors; and
   wherein each processor is arranged to retrieve, from the data storage module, image data in accordance with the respective window or windows allocated to the processor by the scheduler.

The scheduler and/or the processors may be so configured and controlled by software instructions, stored in central or local memories of the system, and executed by the scheduler and/or by the plurality of processors.

The scheduler may be connected to each of the plurality of processors via a respective first communication channel. Each of the plurality of processors may be connected to the data storage module via a respective second communication channel. In some embodiments, the second communication channels may support a higher maximum rate of data transfer than the first communication channels. This may facilitate efficient processing of the windows by the plurality of processors without requiring high bandwidth communication links throughout the whole image processing system or device (e.g. a high-bandwidth data bus). For instance, each first communication channel may be suitably sized for sending relatively small instruction data packets from the scheduler to the processors (e.g. instructions on which window to process), whilst the second communication channel is sized for relatively large data transfers (e.g. of the actual window data itself).

Additionally or alternatively, in a set of embodiments the scheduler and the data storage module are connected to one or more of the plurality of processors via a shared communication channel.

The scheduler may allocate one or more windows to each of the plurality of processors. Each processor may retrieve only a respective portion of the image data corresponding to a window or windows allocated to the processor by the scheduler.

The size of the output image (e.g. the super-resolution image) may be selected based on the size of one or more expected physical structures in the imaged sample. For instance, the size of the output image may be selected so that it has a pixel size corresponding to half, or less, the size of a smallest expected physical structure, and preferably to one fifth, or less, of the size of a smallest expected physical structure. The output image preferably comprises at least four times the number of pixels as the images in the image stack and may comprise at least nine times the number of pixels, or at least 16 times the number of pixels, or even 25 times the number of pixels or more.

Embodiments of the invention are suitable for processing a wide variety of sizes of images and image stacks. For instance, the stack of images may contain only two images but in some embodiments it may comprise at least five images, at least ten images, at least 20 images, at least 100 images or even at least 500 images or more. In a set of embodiments, the stack of images comprises at least K images, where

$$K = \frac{{( \frac{λ}{NA} )}^{2}}{𝒜} ,$$

and where λ is the wavelength of captured light, NA is the numerical aperture of the imaging apparatus that captured the image stack, and [symbol] is the physical area of one pixel of an image sensor of the imaging apparatus that captured the image stack (e.g. the area occupied by each photodetector element of an CCD or CMOS sensor). Additionally or alternatively, the stack of images comprises images captured under different illumination conditions (e.g. different illumination patterns such as those used in Structured Illumination Microscopy (SIM)). In a set of embodiments, the stack of images comprises at least as many images as the number of different illumination conditions used to capture the stack of images. For instance, the stack of images may comprise nine images captured under nine different SIM illumination patterns.

The image processing system may be optimised for processing a particular size or range of sizes of input image data and/or for producing a particular size of output image. For instance, as explained above, the image processing system may comprise a number of processors based on the intended number of windows to be selected which, in turn, may be based on the size of the image data. Furthermore, the image processing system may comprise data storage sufficient for the input image data, the output image and intermediary data produced during the processing. The image processing system may also comprise internal data communication channels with bandwidths sufficient for transferring the intermediary data produced for a particular size of input image without delaying other processing steps.

However, it may be desirable for the image processing system to be operable to efficiently process image data from many different sources and/or of many different sizes. Therefore, in some sets of embodiments, additionally or alternatively, the image data comprises a time-series of images of the entire sample region, and the instructions, when executed, cause:
the system to generate a plurality of stacks of images from the image data, each stack of images being of a different respective part of the sample region;
one or more of the plurality of processors to produce, for each stack of images, an output image (e.g. a super-resolution image) of the respective part of the sample region; and
the system to combine the plurality of output images to produce an output image (e.g. a super-resolution image) of the entire sample region.

Generating a plurality of stacks of images from the image data (i.e. splitting the image data up), processing each stack separately and then combining the results allows the image processing system to be optimised for processing image stacks of a particular size, e.g. using one or more of the measures described above. Input image data can be split into stacks of the optimal size, processed optimally and then combined to produce an output image. In such embodiments the image processing system can benefit from the image-size specific optimisations whilst being able to handle a wide variety of input image data.

The plurality of stacks may be equally sized spatially. At least two of the stacks may overlap (i.e. at least two of the respective parts of the sample region may overlap). This may assist in the combining process. One or more of the stacks of images (e.g. at an edge of the image data) may be padded with artificial image data to ensure that all of the stacks have the same size. This may simplify the processing of the stacks. The artificial image data may comprise an average (e.g. mean) value of image pixels of the stack, or a floor value of the stack.

Combining the plurality of output images may comprise spatially aligning the plurality of output images. It may comprise concatenating and/or superimposing (e.g. in spatially-overlapping regions) the plurality super-resolution images. In some embodiments one or more image stitching algorithms may be used when combining the output images.

The input interface may comprise a physical data interface, e.g., a serial port, a parallel port or a universal serial bus (USB) interface. The input interface may comprise a network interface, e.g., an Ethernet or a wireless local area network (WLAN) interface. The input interface may comprise an internal interface, e.g. between components of the same computing device.

The input interface may be arranged to receive the image data from any suitable source, such as a local data storage device (e.g. a hard drive or a flash storage device), or from a remote device such as a remote server. Additionally or alternatively, the input interface may be operable to receive the image data directly from an imaging apparatus, e.g., from a camera of the imaging apparatus.

Accordingly, when viewed from another aspect the invention provides an imaging system comprising:
an imaging apparatus for producing image data comprising a stack of images, captured at different times, of part or all of a sample region containing a sample; and
an image processing system as disclosed herein, wherein the input interface is arranged to receive the image data from the imaging apparatus.

The invention extends to a method of imaging a sample region containing a sample, the method comprising:
producing image data comprising a stack of images, captured at different times, of part or all of a sample region containing a;
processing said image data according to the method disclosed herein.

The imaging apparatus may be physically distinct from the image processing system. For instance, the imaging apparatus may comprise a microscope or image sensor that can be communicatively coupled to the input interface of the image processing system, permanently or when needed, e.g. during an image capture session and/or to download image data to the input interface. However, in some sets of embodiments the imaging apparatus may be physically integrated with some or all of the image processing system. For example, the imaging system may comprise a single physical device comprising the imaging apparatus and at least the input interface for receiving the image data from the imaging apparatus. The input interface and part or all of the imaging apparatus may be contained within a housing of the device. The device may comprise at least an image sensor of the imaging apparatus. It may also comprise an objective lens and/or other passive or active optical components. Integrating at least part of the image processing system with the imaging apparatus may allow the image processing system to be optimised for that particular apparatus, e.g. for a size of image sensor used by the imaging apparatus. For instance, the input interface may be designed to have a bandwidth that corresponds to an output bandwidth of the imaging apparatus, and/or the image processing system may comprise a number of processors equal to the number of pixels in the image sensor of the imaging apparatus.

Producing the image data may comprise capturing a time-series of images (e.g. using the imaging apparatus). Capturing the time-series of images may comprise illuminating the sample region. The imaging apparatus may comprise an illumination apparatus for illuminating the sample region.

The illumination may be static throughout the capturing (e.g. comprising a static illumination pattern and/or intensity), such that the stack of images comprises images captured under constant (i.e. static) illumination conditions. For instance, the sample region may be illuminated with a static and unchanging light source of a particular wavelength to stimulate fluorescence. Alternatively, the illumination may vary through the capturing, such that the stack of images comprises images captured under varying illumination conditions as explained above.

In some embodiments, the imaging system is a single device comprising the imaging apparatus and the entire image processing system. This may be referred to as a “behind-the-camera” solution.

In one set of embodiments the image processing system is provided by a single device that also provides some or all of the imaging apparatus. An integrated “all-in-one” approach may allow the image processing system to be fully optimised for the imaging apparatus. For instance, the input interface may be designed to have an input bandwidth that matches the output data bandwidth of imaging apparatus. Integrating some or all of the image processing system into the same physical device as the imaging apparatus may also remove reliance on external devices or providers or allow for increased configurability.

According to an aspect of the present invention there is provided a computer- implemented method of processing image data to produce an output image, the method comprising:
receiving image data comprising a stack of images, captured at different times, of part or all of a sample region containing a fluorescing sample;
selecting from the stack of images a plurality of windows, each window comprising a respective stack of spatially-coincident sections of the images;
for each window:
   decomposing the window into eigenimages and corresponding singular values;
   calculating, for each of a plurality of test points in the window, a respective first value as a first function of the eigenimages of the window;
   calculating, for each of the plurality of test points in the window, a respective second value as a second function of the eigenimages of the window; and
   determining, from the first and second values, a respective indicator value for each test point, representative of a likelihood of a fluorophore being present at a location of the sample region corresponding to the test point; and
combining the indicator values to produce an output image of the part or all of the sample region,
   wherein at least one of the decomposing, calculating or determining steps is carried out for a first window of the plurality of windows at the same time as at least one of the decomposing, calculating or determining steps is carried out for a second window of the plurality of windows.

According to another aspect of the present invention there is provided an image processing system for producing output images, comprising:
an input interface for receiving image data comprising a stack of images, captured at different times, of part or all of a sample region containing a fluorescing sample; and
a plurality of processors,
   wherein the image processing system is configured, for each of a plurality of windows selected from the image data, each window comprising a respective stack of spatially-coincident sections of the images, to use one or more of the plurality of processors to:
decompose the window into eigenimages and corresponding singular values;
calculate, for each of a plurality of test points in the window, a respective first value as a first function of the eigenimages of the window;
calculate, for each of the plurality of test points in the window, a respective second value as a function of the eigenimages of the window; and
determine, from the first and second values, a respective indicator value for each test point, representative of a likelihood of a fluorophore being present at a location of the sample region corresponding to the test point; and
   wherein the image processing system is configured to combine the indicator values to produce an output image of the part or all of the sample region, and
   wherein the image processing system is configured to cause at least one of the decomposing, calculating or determining steps to be carried out for a first window of the plurality of windows by a first processor of the plurality of processors, at the same time as at least one of the decomposing, calculating or determining steps is carried out for a second window of the plurality of windows by a second processor of the plurality of processors.

Features of any aspect or embodiment described herein may, wherever appropriate, be applied to any other aspect or embodiment described herein. Where reference is made to different embodiments, it should be understood that these are not necessarily distinct but may overlap. It will be appreciated that all of the preferred features of the method according to the first aspect described above may also apply to the other aspects of the invention.

### BRIEF DESCRIPTION OF THE DRAWINGS

One or more non-limiting examples will now be described, by way of example only, and with reference to the accompanying figures in which:

FIG. 1 is a schematic diagram of an imaging system comprising an image processing system according to embodiments of the present invention;

FIG. 2 is a schematic diagram of the image processing system shown in FIG. 1;

FIGS. 3-8 are schematic diagrams that illustrate steps of an image processing method performed by the image processing system of FIG. 2;

FIG. 9 is a schematic diagram of a first image processing system embodying the invention;

FIG. 10 is a schematic diagram of a second image processing system embodying the invention; and

FIG. 11 is a schematic diagram of an imaging system embodying the invention.

### DETAILED DESCRIPTION

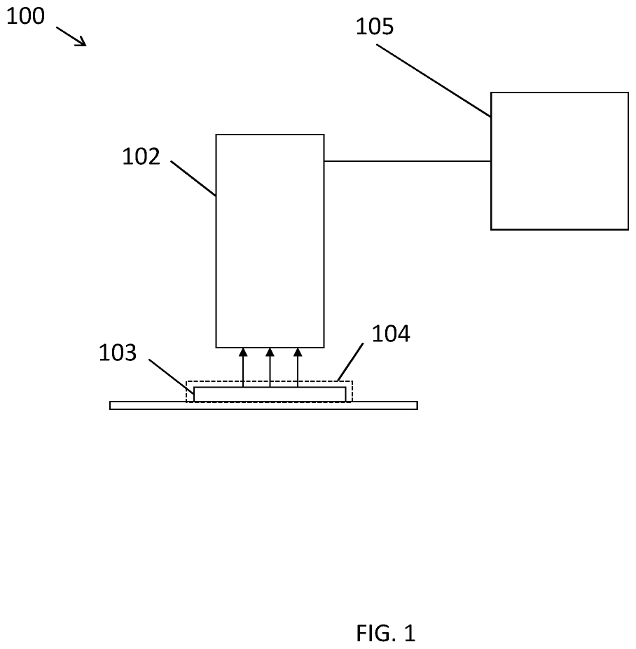

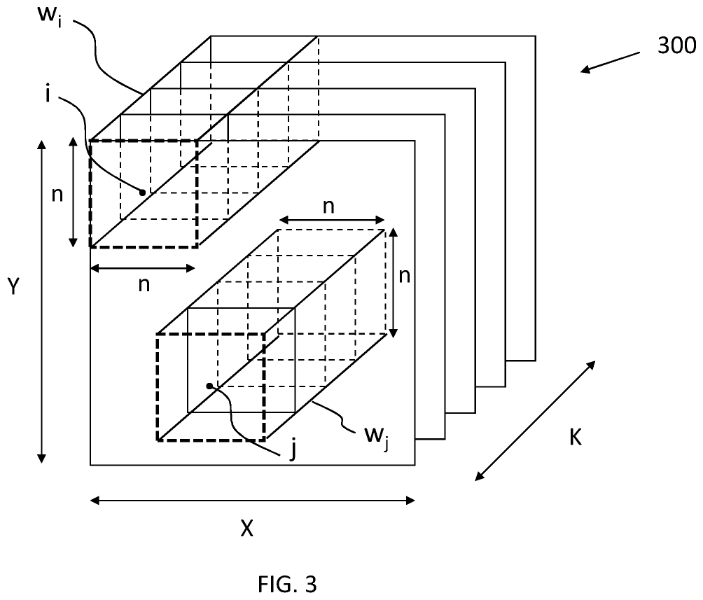

FIG. 1 shows an imaging system 100 comprising a microscope 102 (i.e. an imaging apparatus) that captures image data of a sample 103 that occupies a sample region 104, and an imaging processing system 105 that processes the image data. In this example, the sample 103 is a fluorescing sample that emits fluorescent light, and this light is captured by the microscope 102. The microscope 102 has an objective lens, an image sensor (e.g. a CCD or CMOS chip), and other conventional components. The microscope 102 has a numerical aperture, NA, and the fluorescent light captured by the microscope has a wavelength, A. The microscope 102 captures a series of images of the sample 103 at different times and outputs the resulting time-sequential stack of images 300 (shown in FIG. 3) as digital image data to the image processing system 105. Each image in the stack of images 300 captured by the microscope 102 is the same size, with a width X and a height Y (e.g. measured in numbers of pixels). There are K images in the stack 300. K is chosen to be greater than (λ/NA)² divided by the physical area occupied by one pixel on the image sensor of the microscope. In an example not illustrated here, the imaging system 100 comprises a light source that illuminates the sample 103 with different illumination patterns (e.g. a SIM light source). In such examples, the time-series of images of the sample 103 features at least one image of the sample 103 being illuminated by each illuminating pattern. K may also be chosen at least in part on an expected degree of motion of particles in the sample.

The image processing system 105 processes the image data to produce a super-resolution image of the sample 103 that has a width NX and height NY, where N is, for instance, between five and 20. N indicates the expansion of the image or the corresponding reduction in effective pixel size.

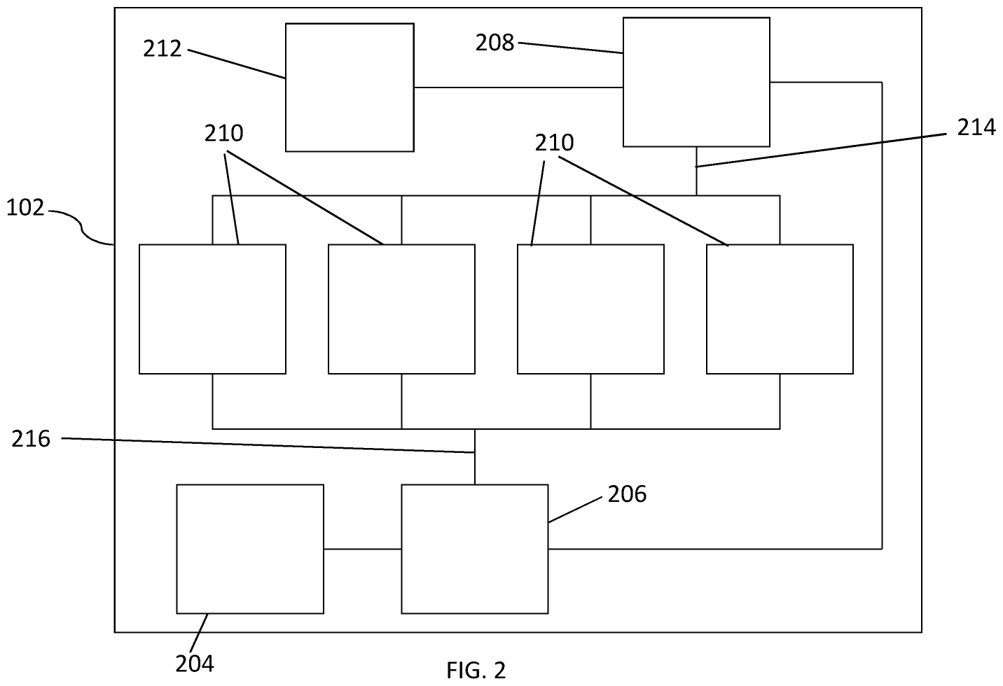

FIG. 2 illustrates the image processing system 105 in more detail. The image processing system 105 comprises an input interface 204 (e.g. a USB port), data storage 206 (e.g. comprising volatile and/or non-volatile memories), a main processor 208, a plurality of auxiliary processors 210 and a physical user interface 212 (e.g. comprising a display screen and a keyboard). The main processor 208 operates as a scheduler and a job distributer and is also responsible for handling inputs from and outputs to the user interface 212. The data storage 206 is used for storing image data but may also provide software memory on which software for execution by the processors 208, 210 is stored. The image processing system 105 may be implemented in a single location (e.g. as a single computing appliance), or it may be physically distributed. The main processor 208 is connected to each of the auxiliary processors 210 via a respective first communication channel 214. Each of the auxiliary processors 210 is connected to the data storage 206 via a respective second communication channel 216. The second communication channels 216 support a higher maximum rate of data transfer than the first communication channels 214. The operation of the image processing system 105 will now be described with additional reference to FIGS. 3-7.

The illustrated architecture of first and second communication channels 214, 216 with different data transfer rates is not essential. In other embodiments, for instance, the main and auxiliary processors 208, 210 may simply be connected to a common bus. One or more of the auxiliary processors 210 may be connected to the main processor 208 via one or more other processors (e.g. where an auxiliary processor 210 is located remotely with communication passing through a main core of a remote device).

In a first step, illustrated in FIG. 3, the image stack 300 is received by the input interface 204 and stored in the data storage 206. The main processor 208 establishes a plurality of windows wᵢ over the image stack 300, with each window wᵢ defining a respective set of spatially-coincident image sections that contains a respective section of each image in the stack. All the image sections of a given window have the same dimensions and the same position within each image of the stack. Each window wᵢ is centred on a different pixel i=(xᵢ, yᵢ) in the X-Y plane. The windows wᵢ are square, and all the same size, having dimensions of n×n pixels. A window may overlap one or more other windows.

In the next step, the main processor 208 (acting as a scheduler) allocates a different respective window to each auxiliary processor 210 by informing the auxiliary processor 210 of the coordinates of the window in the image stack 300 (e.g. its centre coordinate, i, assuming the dimension n is already known to the auxiliary processors 210). The auxiliary processors 210 retrieve the image data of their allocated window from the data storage 206. Alternatively, the main processor 208 may retrieve the image data of the allocated window itself and pass it to the respective auxiliary processor 210. The main processor 208 may also, in some examples, retrieve image data and perform image processing operations itself (e.g. alongside the auxiliary processors 210).

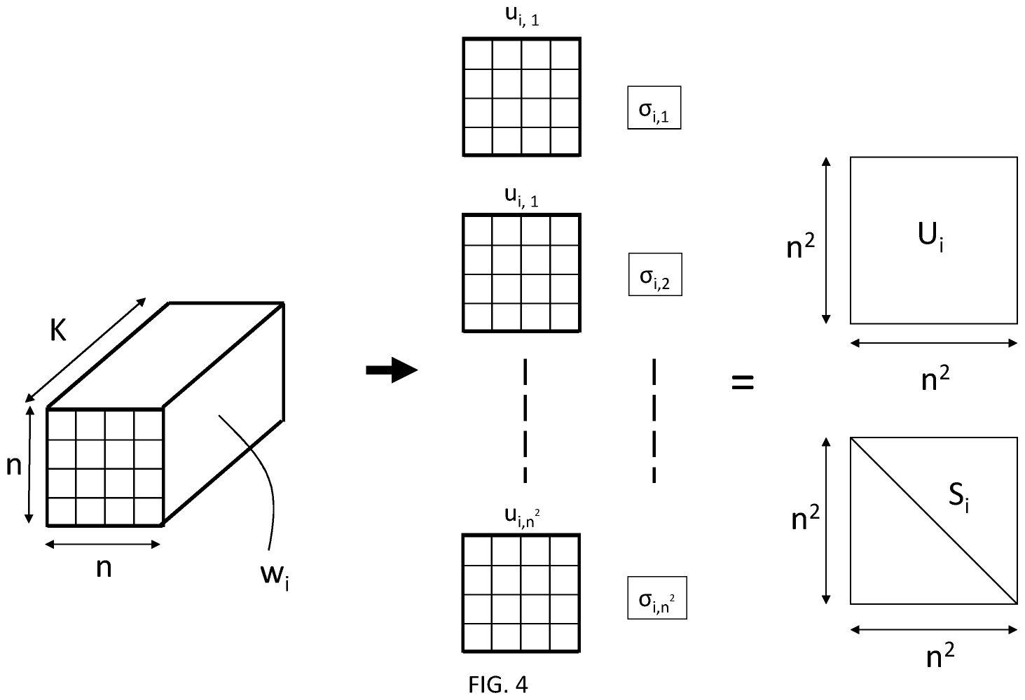

As illustrated in FIG. 4, each auxiliary processor 210 performs eigenvalue decomposition (ED) of the data in its allocated window to produce an eigenimage matrix Uᵢ and a singular value matrix Sᵢ. Each eigenimage matrix Uᵢ consists of n² eigenimages Uᵢ of size 1×n², and the singular value matrix Sᵢ is a diagonal matrix containing n² associated singular values σᵢ for that window (an array containing only the diagonal elements of the matrix Sᵢ may alternatively be used). Because there are a plurality of auxiliary processors 210, a plurality of windows are decomposed at the same time (i.e. in parallel).

If there are more windows than available auxiliary processors 210, the additional windows are queued to be decomposed by the next available processor 210. The auxiliary processors 210 continue to be allocated windows to decompose until an eigenimage matrix Uᵢ and a singular value matrix Sᵢ has been produced for all of the windows. These matrices are stored in the data storage 206.

The main processor 208 then displays all of the singular values of to a user via the user interface 212. The user reviews the singular values σᵢ and selects suitable first and second weight functions to apply to the eigenvalues. In this example, the first and second weight functions are both step functions defined by a common threshold singular valueσ₀ chosen by the user. The user may select the threshold using heuristic techniques (e.g. based on a threshold that previously produced a high quality final image). The first weight function selects all eigenimages uᵢ with a corresponding singular value σᵢ greater than or equal to the threshold σ₀. The second weight function selects all eigenimages uᵢ with a corresponding singular value of less than the threshold σ₀. In other examples, the main processor 208 may instead select a suitable common threshold σ₀ itself without user input, or a fixed (e.g. hard-coded) predetermined threshold σ₀ may be used. Other weight functions may also be used.

As explained below, the threshold σ₀ will be used to separate the eigenimages uᵢ into those corresponding to fluorescent signals in the sample region 104 and those associated with noise. Those eigenimages uᵢ with an associated singular value σᵢ that is greater than the threshold go are categorised as representing fluorescent signals and those with a singular value of that less than the threshold σ₀ are categorised as representing noise. It will be appreciated that the same technique may be applied to image data of samples in which intensity fluctuations arise due to other effects such as motion.

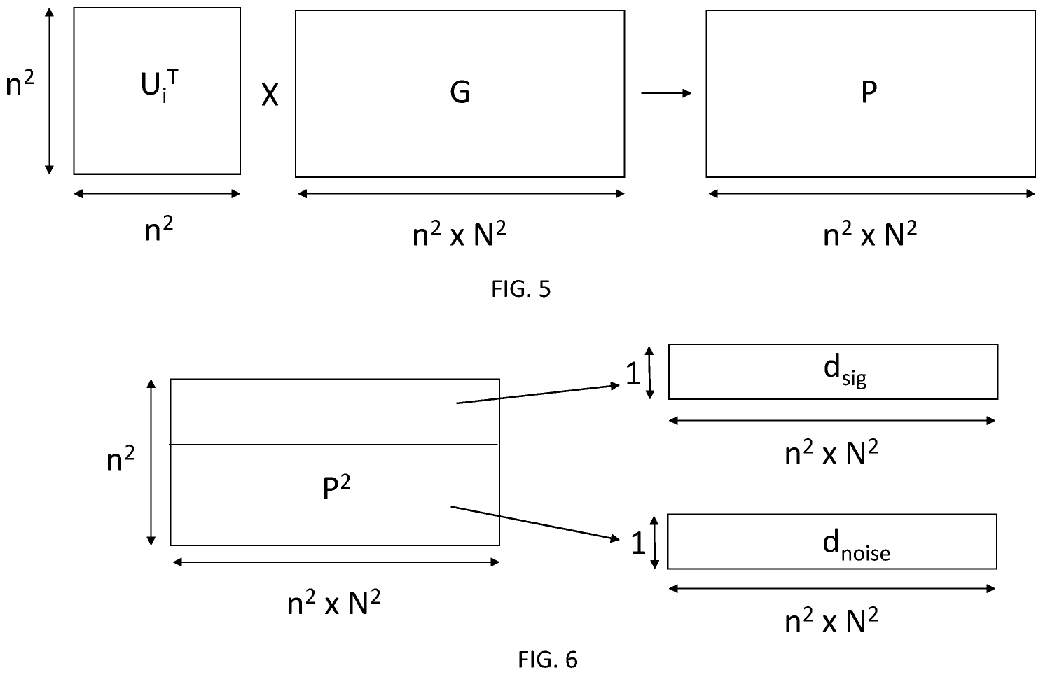

In the next step, illustrated in FIG. 5, the processors 210 are used to establish first and second values for a series of test points rₜₑₛₜ in each window. The first and second values represent the relative signal and noise contributions of each of the eigenimages to the different test points rₜₑₛₜ. The test points represent respective pixels in the output super-resolution image. There are therefore N² test points per input image pixel, where N is an expansion factor for the output image.

To determine the values, the image processing system 105 projects a point spread function (PSF) of each test point onto each eigenimage of each window. To do so the processors 210 multiply each of the eigenimage matrices Uᵢ with a test matrix G that represents the PSF for each of the test points rₜₑₛₜ within the window:

Pᵢ=UᵢG

There are N² test points per original pixel, n² pixels per window, and n² eigenimages per window, so the test matrix G has dimensions of n²×n²N². The matrix multiplication for at least some of the windows, and potentially for each window, is performed on a different respective auxiliary processor 210, so that the matrix Pᵢ for multiple windows is determined simultaneously (i.e. in parallel). If there are more windows than there are auxiliary processors 210, the additional windows are queued for processing when a processor 210 becomes available.

The resulting matrices Pᵢ are squared element-wise to produce Pᵢ². The matrix Pᵢ² is then split into two groups of rows according to the threshold σ₀. The first group of rows corresponds to eigenvalues that have a singular value that is equal to or above the threshold and the second group of rows corresponds to eigenvalues that have a singular value that is below the threshold. The first group of rows are summed to produce a signal contribution matrix d_{sig} and the second group of rows are summed to produce a noise contribution matrix dₙₒᵢₛₑ. The signal contribution matrix d_{sig} contains the first values for teach test point (i.e. the contributions to each test point of the eigenimages of the window associated with fluorescent signals in the sample region 104). The noise contribution matrix dₙₒᵢₛₑ contains the second values for each test point (i.e. the contributions to each test point of the eigenimages of the window associated with noise).

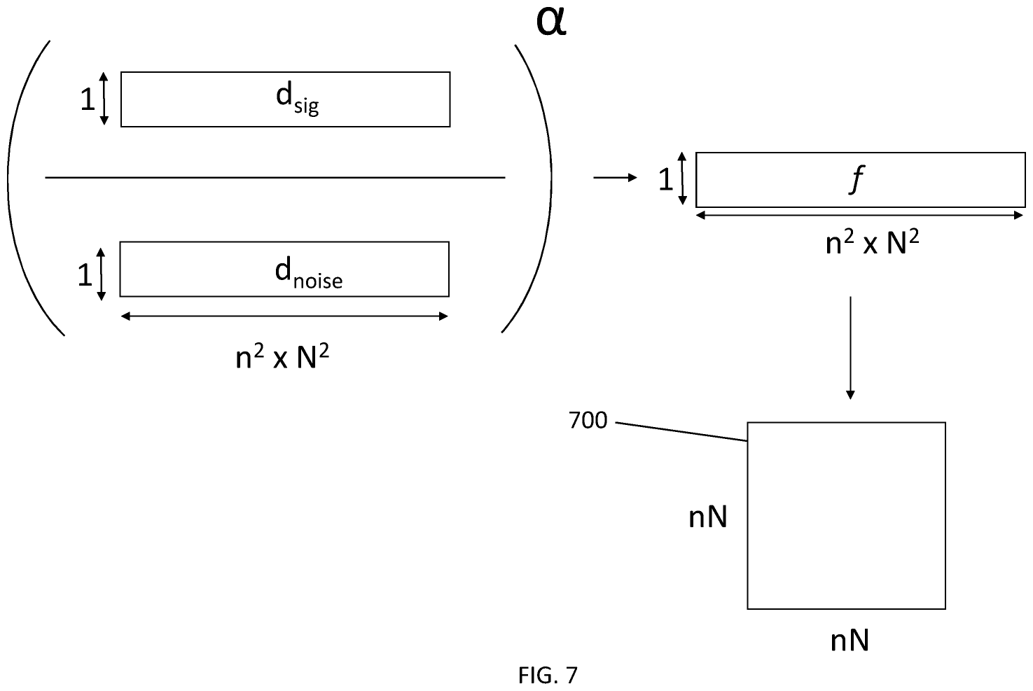

Next, as shown in FIG. 7, the signal contribution matrix d_{sig} is divided by the noise contribution matrix dₙₒᵢₛₑ (i.e. the first values are divided by the second values) and the result is raised to a contrast parameter α to calculate an indicator value matrix f for all of the test points in the window. The contrast parameter α may be selected by a user or may be predetermined. Each indicator value in the matrix f represents a likelihood of a fluorophore being present in the sample 103 at a position corresponding to the respective test point. They have a very large number at a likely fluorophore location and a small number otherwise. They do not equal true statistical likelihood (e.g. they are not scaled between zero and one), but they may correlate with statistic likelihood. The elements of the 1×n²N² indicator function matrix fare then rearranged to produce a square nN×nN super-resolution window 700.

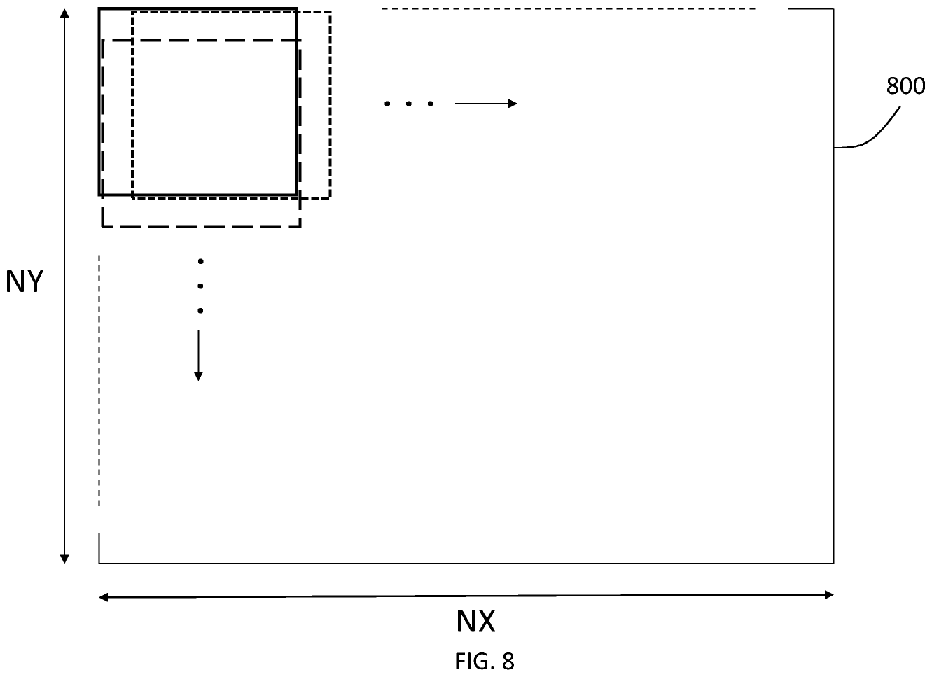

The auxiliary processors 210 return the super-resolution windows 700 to the data storage 206. Finally, as illustrated in FIG. 8, the main processor 208 combines all of the super-resolution windows 700 to produce the final super-resolution image 800 of width NX and height NY, by aligning the windows spatially and combining (e.g. adding or mean averaging) values in the overlapping portions.

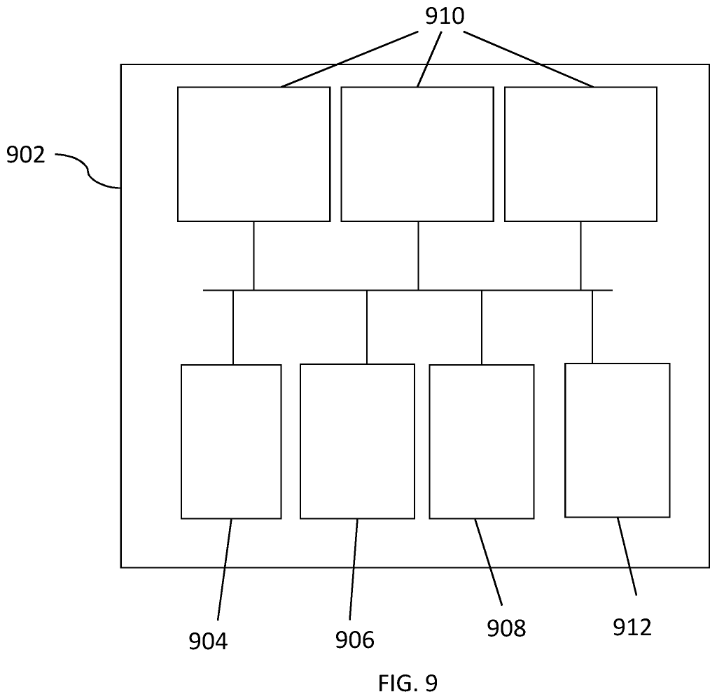

FIG. 9 shows an image processing system 902 according to a first set of embodiments. The image processing system 902 is a single computing device (e.g. a workstation or personal computer). The image processing system 902 comprises an input interface 904 (e.g. a USB interface), a memory 906, a central processing unit 908, a plurality of graphical processing units 910, and a user interface 912 (e.g. a display screen and keyboard) The image processing system 902 operates in the same way as the system explained above with reference to FIGS. 2-8, with the central processing 908 acting as the main processor and the graphical processing units 910 acting as auxiliary processors.

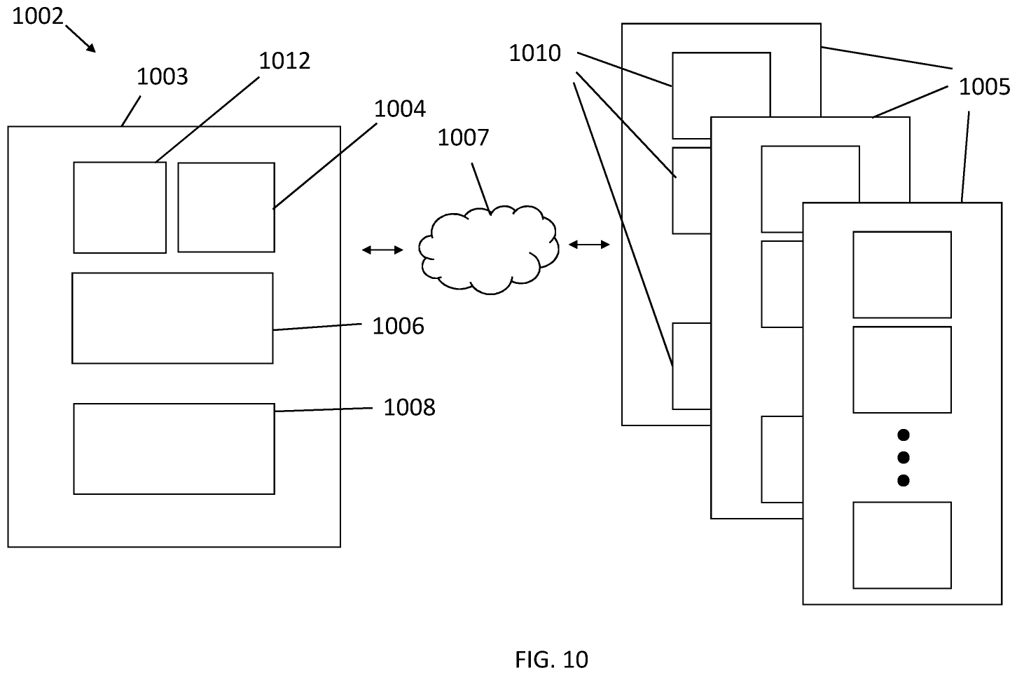

FIG. 10 shows an image processing system 1002 according to a second set of embodiments. The image processing system 1002 comprises a local computing device 1003 and a plurality of remote servers 1005, which are connected via a network 1007 (e.g. a local area network, or the Internet). The local computing device 1003 comprises an input interface 1004, a memory 1006, a central processing unit 1008 and a user interface 1012. The remote servers 1005 each comprise a plurality of graphical processing units 1010.

The image processing system 1002 operates in the same way as the system explained above with reference to FIGS. 2-8, with the central processing 1008 acting as the main processor and the graphical processing units 1010 on the remote servers acting as auxiliary processors.

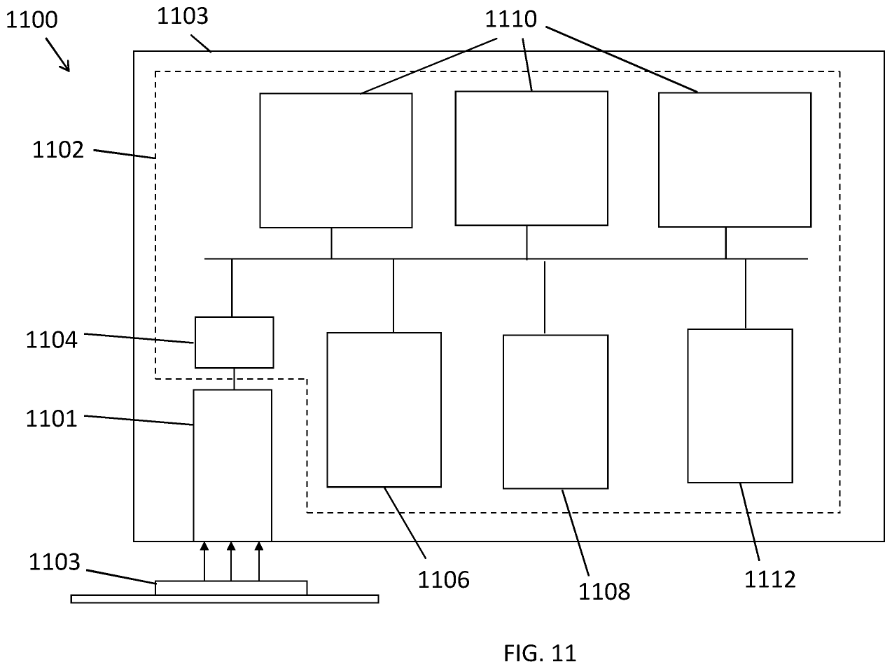

FIG. 11 shows a super-resolution imaging system 1100 embodying the invention. The imaging system comprises an imaging device 1101 (e.g. a microscope) for capturing image data of a sample 1103, and an image processing system 1102.

The imaging unit 1101 and image processing system 1102 may contained within a common housing 1103, although this is not essential. The image processing system 1102 comprises an input interface 1104 that receives image data directly from the imaging device 1101, a memory 1106, a central processing unit 1108, a plurality of graphical processing units 1110 and a user interface 1112. Alternatively, a physical user interface 1112 (e.g. a display) may be provided outside the device 1103. This arrangement may be referred to as a “behind-the-camera” processing system. In some embodiments, the memory 1106, central processing unit 1108 and plurality of graphical processing units 1010 may be provided as an integrated circuit—e.g. a system-on-chip (SoC). This may be referred to as a “chip-behind-the-camera” system. The image processing chip may be physically packaged (e.g. stacked) with the image sensor chip of the imaging device 1101.

The image processing system 1102 operates in the same way as the system explained above with reference to FIGS. 2-8, with the central processing unit 1108 acting as the main processor and the graphical processing units 1110 acting as auxiliary processors. The imaging processing system 1102 may advantageously be optimised for the specific imaging device 1101—e.g. by selecting the number of GPUs 1110 and/or memory capacity and/or internal communication bandwidth based at least partly on the size of an image sensor of the imaging device 1101.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A computer-implemented method of processing image data to produce an output image, the method comprising:
receiving image data comprising a stack of images, captured at different times, of part or all of a sample region containing a sample;
selecting from the stack of images a plurality of windows, each window comprising a respective stack of spatially-coincident sections of the images;
for each window:
decomposing the window into eigenimages and corresponding singular values;
calculating, for each of a plurality of test points in the window, a respective first value as a first function of the eigenimages of the window;
calculating, for each of the plurality of test points in the window, a respective second value as a second function of the eigenimages of the window; and
determining, from the first and second values, a respective indicator value for each test point, representative of a likelihood of a part of said sample being present at a location of the sample region corresponding to the test point; and
combining the indicator values to produce an output image of the part or all of the sample region,
wherein at least one of the decomposing, calculating or determining steps is carried out for a first window of the plurality of windows at the same time as at least one of the decomposing, calculating or determining steps is carried out for a second window of the plurality of windows.

2. The method of processing image data as claimed in claim 1, comprising decomposing the first window into eigenimages and corresponding singular values at the same time as decomposing the second window into eigenimages and corresponding singular values.

3. The method of processing image data as claimed in claim 1, comprising calculating the respective first or second values for the first window at the same time as calculating the first or second values for the second window.

4. The method of processing image data as claimed in claim 1, wherein calculating each first value includes applying a first weight function to eigenimages of the window, and calculating each second value includes applying a second weight function to eigenimages of the window.

5. The method of processing image data as claimed in claim 4, comprising a computer determining the first and/or second weight function based on the eigenimages and corresponding singular values of a plurality of the windows.

6. The method of processing image data as claimed in claim 4, comprising receiving an input from a user and determining the first and/or second weight function based at least partially on said input.

7. The method of processing image data as claimed in claim 1, wherein calculating the first value for each test point comprises calculating a first contribution to the test point of the eigenimages of the window that have a corresponding singular value greater than a first threshold value, and calculating the second value for each test point comprises calculating a second contribution to the test point of the eigenimages of the window that have a corresponding singular value less than a second threshold value.

8. The method of processing image data as claimed in claim 1, wherein each image in the stack of images comprises a plurality of pixels, and the method comprises selecting a respective window centred on each of the pixels of the images in the stack of images.

9. The method of processing image data as claimed in claim 1, wherein the image data comprises a time-series of images of the entire sample region, and wherein the method further comprises:
generating a plurality of stacks of images from the image data, each stack of images being of a different respective part of the sample region;
processing each of the stacks of images to produce a respective output image of each part of the sample region; and
combining the plurality of output images to produce an output image of the entire sample region.

10-11. (canceled)

12. The method as claimed in claim 9, comprising padding one or more stacks of images with artificial image data.

13. (canceled)

14. The method as claimed in claim 1, wherein the sample comprises one or more moving parts, and the respective indicator value for one or more test points represents a likelihood of a moving part of said sample being present at a location of the sample region corresponding to the test point.

15. The method as claimed in claim 1, wherein the sample is a fluorescing sample, and the respective indicator value for one or more test points represents a likelihood of a fluorophore being present at a location of the sample region corresponding to the test point.

16. (canceled)

17. An image processing system for producing output images, comprising:
an input interface for receiving image data comprising a stack of images, captured at different times, of part or all of a sample region containing a sample; and
a plurality of processors,
wherein the image processing system is configured, for each of a plurality of windows selected from the image data, each window comprising a respective stack of spatially-coincident sections of the images, to use one or more of the plurality of processors to:
decompose the window into eigenimages and corresponding singular values;
calculate, for each of a plurality of test points in the window, a respective first value as a first function of the eigenimages of the window;
calculate, for each of the plurality of test points in the window, a respective second value as a function of the eigenimages of the window; and
determine, from the first and second values, a respective indicator value for each test point, representative of a likelihood of a part of said sample being present at a location of the sample region corresponding to the test point; and
wherein the image processing system is configured to combine the indicator values to produce an output image of the part or all of the sample region, and
wherein the image processing system is configured to cause at least one of the decomposing, calculating or determining steps to be carried out for a first window of the plurality of windows by a first processor of the plurality of processors, at the same time as at least one of the decomposing, calculating or determining steps is carried out for a second window of the plurality of windows by a second processor of the plurality of processors.

18-19. (canceled)

20. The image processing system as claimed in claim 17, wherein calculating each first value includes applying a first weight function to eigenimages of the window, and calculating each second value includes applying a second weight function to eigenimages of the window, and the image processing system comprises a user interface for receiving an input from a user for determining the first and/or second weight function.

21-24. (canceled)

25. The image processing system as claimed in claim 17, comprising:
a data storage module arranged to store the image data; and
a scheduler,
wherein the scheduler is configured to define the plurality of windows and to allocate each window to a respective processor of the plurality of processors; and
wherein each processor is arranged to retrieve, from the data storage module, image data in accordance with the respective window or windows allocated to the processor by the scheduler.

26. The image processing system as claimed in claim 25, wherein the scheduler is connected to each of the plurality of processors via a respective first communication channel, and each of the plurality of processors is connected to the data storage module via a respective second communication channel, wherein the second communication channels support a higher maximum rate of data transfer than the first communication channels.

27. The image processing system as claimed in claim 25, wherein the scheduler comprises a central processing unit or a core of a central processing unit.

28. The image processing system as claimed in claim 17, wherein each of the plurality of processors comprises a respective graphics processing unit (GPU) or GPU core.

29-30. (canceled)

31. An imaging system comprising:
an imaging apparatus for producing image data comprising a stack of images, captured at different times, of part or all of a sample region containing a sample; and
an image processing system comprising:
an input interface arranged to receive the image data from the imaging apparatus; and
a plurality of processors, wherein the image processing system is configured, for each of a plurality of windows selected from the image data, each window comprising a respective stack of spatially-coincident sections of the images, to use one or more of the plurality of processors to:
decompose the window into eigenimages and corresponding singular values;
calculate, for each of a plurality of test points in the window, a respective first value as a first function of the eigenimages of the window;
calculate, for each of the plurality of test points in the window, a respective second value as a function of the eigenimages of the window; and
determine, from the first and second values, a respective indicator value for each test point, representative of a likelihood of a part of said sample being present at a location of the sample region corresponding to the test point; and
wherein the image processing system is configured to combine the indicator values to produce an output image of the part or all of the sample region, and
wherein the image processing system is configured to cause at least one of the decomposing, calculating or determining steps to be carried out for a first window of the plurality of windows by a first processor of the plurality of processors, at the same time as at least one of the decomposing, calculating or determining steps is carried out for a second window of the plurality of windows by a second processor of the plurality of processor.

32. The imaging system as claimed in claim 31, wherein the imaging apparatus is a microscope.
